(19) United States
(12) Patent Application Publication
(10) Pub. No.: US 2013/0107400 A1
(43) Pub. Date: May 2, 2013

(54) SYSTEM FOR MONITORING A MACHINE USING A DIGITAL PROTECTIVE RELAY

(71) Applicants: Xuedong Meng, Ottawa (CA); David Lynn Linkenauger, Williamsburg, VA (US); Prabhakar Neti, Rexford, NY (US); Mills Thomas Robinson, Virginia Beach, VA (US); Pinjia Zhang, Clifton Park, NY (US)

(72) Inventors: Xuedong Meng, Ottawa (CA); David Lynn Linkenauger, Williamsburg, VA (US); Prabhakar Neti, Rexford, NY (US); Mills Thomas Robinson, Virginia Beach, VA (US); Pinjia Zhang, Clifton Park, NY (US)

(73) Assignee: GENERAL ELECTRIC COMPANY, Schenectady, NY (US)

(21) Appl. No.: 13/285,418

(22) Filed: Oct. 31, 2011

(51) Int. Cl. H02H 7/06

(52) U.S. Cl. 361/21

(57) ABSTRACT

A system for monitoring a machine is provided. The system includes a digital protective relay, a communications network, and a central server. The digital protective relay is connected to the machine, and samples at least one parameter of the machine at a rate of at least about twelve samples per power cycle. The central server is located remotely from the machine for receiving the at least one parameter from the machine. The communications network provides a connection between the digital protective relay and the center server for sending a data signal representing the at least one parameter of the machine.

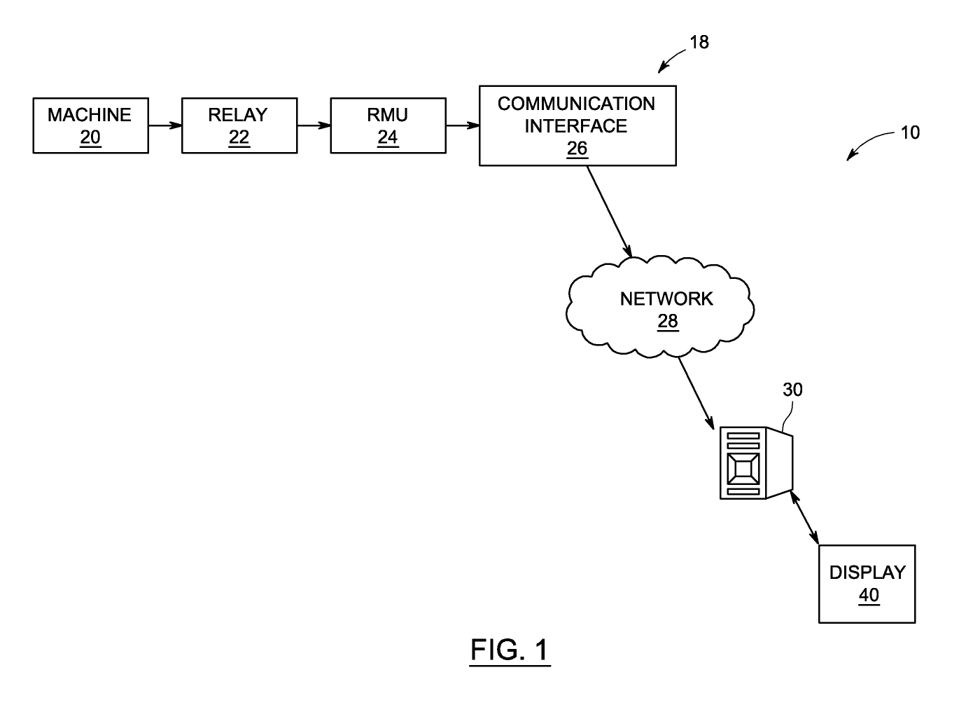

### BACKGROUND OF THE INVENTION

The subject matter disclosed herein relates to a system for monitoring a machine, and particularly to a system for monitoring a machine having a digital protective relay connected to the machine.

The high cost of unreliability and forced outages of machines is well known. Improper maintenance or operational anomaly detection may lead to machine-forced outages. Early detection of such anomalies is important in preventing and reducing lengthy machine forced outages, and may be especially prevalent in the context of motors. Accordingly, the following description may focus on motors but the teachings are not limited to motors and could be applied to any machine from which data may be extracted.

Mechanical machines such as, for example, motors, may require monitoring of various operations conditions to ensure reliable operation. In one approach, an on-site monitoring system may be provided in an effort to monitor the motor. Specifically, the on-site monitoring system may include one or more on-site sensors and on-site monitoring equipment. However, several drawbacks exist with on-site monitoring systems. For example, sometimes the personnel who are available on-site, such as at a customer site, do not have the knowledge or expertise to perform diagnostic analysis of the data collected by the on-site monitoring system. Moreover, the use of sensors to monitor various operating conditions of the motor may add cost and complexity to the on-site monitoring system as well.

### BRIEF DESCRIPTION OF THE INVENTION

According to one aspect of the invention, a system for monitoring a machine is provided. The system includes a digital protective relay, a communications network, and a central server. The digital protective relay is connected to the machine, and samples at least one parameter of the machine at a rate of at least about twelve samples per power cycle. The central server is located remotely from the machine for receiving the at least one parameter from the machine. The communications network provides a connection between the digital protective relay and the central server for sending a data signal representing the at least one parameter of the machine.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawing in which an exemplary schematic diagram of a system for monitoring a machine is illustrated.

The detailed description explains embodiments of the invention, together with advantages and features, by way of example with reference to the drawing in which the system for monitoring a machine is illustrated.

### DETAILED DESCRIPTION OF THE INVENTION

As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality.

Referring now to the drawing, a schematic illustration of embodiment of an exemplary power system 10 is illustrated. The power system 10 includes machine monitoring system 18 having a machine 20, a digital protective relay 22, a remote monitoring unit (“RMU”) 24, a communications interface 26, a communications network 28, and a server 30. The machine 20 may be any type of mechanical machine such as, for example, a motor or a generator. In one exemplary embodiment, the machine 20 is a motor having a power output of typically 500 HP or up, however it is to be understood that less powerful motor may be used as well. The digital protective relay 22 is in communication with the machine 20, and is used for the protection and sampling data for monitoring of the machine 20.

The digital protective relay 22 includes a microprocessor (not shown) for monitoring the machine 20 for at least one operating parameter such as, for example, a voltage waveform and a current waveform. Specifically, the microprocessor of the digital protective relay 22 may include control logic for sampling operating parameters from the machine 20 at a specified interval of at least about twelve samples per power cycle of the power system 10. In one embodiment, the digital protective relay 22 samples operating parameters from the machine 20 at a specified interval between about twelve samples per power cycle to about sixty-four samples per power cycle. Based on the values of the operating parameters of the machine 20, the digital protective relay 20 includes control logic for the detection of electrical faults and some mechanical faults in the machine 20, and selectively causes power to be cut-off from the machine 20 in the event an electrical fault or a mechanical fault is detected.

The digital protective relay 22 is in communication with the RMU 24. The RMU 24 is any type of computing device having control logic for monitoring the digital protective relay 22 for data, and is described in detail below. The RMU 24 is in communication with the communication interface 26. The communication interface 26 is any type of device that facilitates communication between the RMU 24 and the communication network 28. For example, in one embodiment, the communication interface 26 may be a wireless communication device such as an antenna.

The communication network 28 provides a connection between the digital protective relay 22 and the central server 30. In one embodiment, the communications network 28 may be a cellular network, however it is to be understood that other approaches exist as well for connecting the digital protective relay 22 and the RMU 24 to the central server 30. The communication network 28 is a secure network connection between the digital protective relay 22 and the central server 30, where data sampled by the digital protective relay 22 is communicated to the RMU 24 sent over the communication network 28 to the central server 30. Specifically, the communication network 28 is a one-way network connection that is configured such that a signal may only be communicated from the digital protective relay 22 to the central server 30. A one-way network connection generally ensures the security of data being sent from the digital protective relay 22 to the central server 30. The connection is generally secure because there is no opportunity to send data back from the central server 30 to the digital protective relay 22. Sending data back to the digital protective relay 22 may modify certain operational or safety settings of the digital protective relay 22, which in turn may affect operation of the machine 20.

The central server 30 is remotely located from the machine 20. For example, the machine 20 may be located at a customer site, and the central server 30 may be located at a facility several kilometers from the customer site. In one embodiment, the facility is a corporate office such as, for example, a research facility where the data sampled from the machine 20 is monitored and diagnosed. That is, the personnel at the facility typically have the knowledge or expertise to perform diagnostic analysis of the data sampled by the digital protective relay 22. This tends to reduce or eliminate the need for on-site personnel located at the customer site.

The data from the digital protective relay 22 is sent over the communication network 28 at a specified interval of time. For example, in one embodiment, the data is sent from the digital protective relay 22 over the network 28 and to the central server 30 at a frequency of about once a week. In one exemplary embodiment, the RMU 24 may also include control logic for converting the data received from the digital protective relay 22 into a format for subsequent data processing or analysis. Specifically, in one embodiment, the data from the digital protective relay 22 may conform to the Modbus communications protocol. The RMU 24 includes control logic for reading the Modbus registers, and converting the data from the Modbus protocol into a format that may be subsequently processed. For example, in one embodiment, the RMU 24 includes control logic for converting the Modbus data into a comma-separated values (“CSV”) format. The data in the CSV format is then sent over the network 28 to the central server 30.

Alternatively, in another embodiment, the central server 30 may include control logic for converting the data received from the digital protective relay 22 into a format for subsequent data processing or analysis. For example, the data from the digital protective relay 22 may be in a format conforming to IEEE C37.111, which is referred to as the COMTRADE Standard (Common Format for Transient Data Exchange). The RMU 24 includes control logic for monitoring the digital protective relay 22 for the data in the COMTRADE format, and compresses the data before sending the data to the communication interface 26. The compressed data is then sent over the network 28 to the central server 30. The central server 30 includes control logic for converting the compressed data in the COMTRADE format to a format that may be subsequently processed. Specifically, for example, in one embodiment the central server 30 includes application software for parsing the data in the COMTRADE format into the CSV format.

The central server 30 may further include control logic for translating the data from time domain dynamic data into frequency domain data. Specifically, in one embodiment the central server 30 includes control logic for transforming the time domain data into frequency domain data using a fast Fourier transform (“FFT”). The frequency domain data represents a current spectrum of the machine 20 in the frequency domain, where a magnitude of the current waveform (measured in dB) is plotted versus frequency (measured in Hertz).

Current signature analysis (“CSA”) may be performed to determine any irregularities or impending faults within the machine 20 during operation. Specifically, CSA involves analyzing the current spectrum of the machine 20, where specific spectral components in the current spectrum may indicate the presence of a fault. Some types of faults that may be detected through CSA include, but are not limited to, broken or damaged rotor bars, a damaged bearing, misalignment of shaft, or static or dynamic eccentricity. The central server 30 includes at least one specific spectral component saved in the memory of the central server 30 that indicates or represents a specific fault of the machine 20. For example, in one illustrative embodiment, a motor in North America (having a line frequency peak of about 60 Hertz) would have a current spectrum with a large peak at about 60 Hertz and sidebands at about 59 and 61 Hertz. If the sidebands have a magnitude difference of about 45 to 50 dB compared to the 60 Hz peak, damaged rotor bars are likely. The central server 30 further includes control logic for comparing the specific spectral components with the current spectrum of the machine 20 to determine if a specific fault exists.

The central server 30 further includes control logic for creating a graphical signal representing the current spectrum. The graphical signal of the current spectrum is sent to a display 40. The display 40 may be, for example, a liquid crystal display (“LCD”) screen used to display graphics and text. The display 40 may show the current spectrum of the machine 20. Thus, personnel at the facility where the central server 30 is located at may have the ability to view the current spectrum and confirm that a specific fault exists. Therefore, if the central server 30 determines that a specific fault exists, the current spectrum may be viewed on the display 40 by personnel to confirm that the fault indeed actually exists.

In one embodiment, the digital protective relay 22 may sample the voltage waveform of the machine 20. Specifically, the central server 30 may include control logic for creating a graphical signal on the display 40 representing the voltage waveform versus time. The central server 30 may also include control logic for performing harmonic distortion analysis on the voltage waveform data to determine the quality of power supplied to the machine 20. The central server 30 may also include control logic for calculating a speed estimate (in the event that the machine 20 is an induction motor), a torque estimate and an efficiency estimate of the machine 20. The speed estimate, torque estimate, and the efficiency estimate are based at least in part on the current waveform and the voltage waveform.

The central server 30 may also include control logic for transforming the time domain data representing the voltage waveform into frequency domain data using FFT. The central server 30 further includes control logic for creating a graphical signal representing the frequency domain data of the voltage waveform, where a magnitude of the voltage waveform (measured in dB) is plotted versus the frequency (measured in Hertz) to create a voltage spectrum. The graphical signal of the voltage spectrum is sent to the display 40. The current spectrum and the voltage spectrum of the machine 20 may be used to perform electrical signature analysis (“ESA”), which analyzes both the current and the voltage spectrum of the machine 20. It should be noted that while current signature analysis is discussed, other mathematical operations may be conducted on the voltage waveform data and current waveform data prior to current signature analysis as well.

The machine monitoring system 18 has the machine 20 located at a customer site and the central server 30 located remotely at a facility. The facility typically has personnel such as, for example, operations engineers. The operations engineers have the knowledge or expertise that is generally needed to monitor and diagnose the machine. This tends to reduce or eliminate the need for on-site personnel located at the customer site. Moreover, the machine monitoring system 18 may not typically include numerous sensors to monitor various operating conditions of the machine 20, unlike at least some of the monitoring system currently available. Thus, the machine monitoring system 18 may have reduced cost and complexity when compared to some other machine monitoring systems that are currently available.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for monitoring a machine, the system comprising:
a digital protective relay connected to the machine and sampling at least one parameter of the machine at a rate of at least about twelve samples per power cycle;
a communications network; and
a central server located remotely from the machine, the communications network providing a connection between the digital protective relay and the central server for sending a data signal representing the at least one parameter of the machine.

2. The system as recited in claim 1, wherein the communications network provides a one-way network connection such that the data signal is only communicated from the digital protective relay to the central server.

3. The system as recited in claim 1, wherein the at least parameter from the machine is at least one of a current waveform and a voltage waveform.

4. The system as recited in claim 3, wherein the central server includes control logic for transforming the data signal representing the at least one parameter of the machine from a time domain signal into a frequency domain signal.

5. The system as recited in claim 4, wherein a fast Fourier transform (“FFT”) is used to transform the time domain signal into a frequency domain signal.

6. The system as recited in claim 4, wherein the central server includes control logic for creating graphical data representing the frequency domain signal, and wherein the graphical data is shown on a display.

7. The system as recited in claim 6, wherein the central server includes a memory, wherein a specific spectral component is saved on the memory of the central server, and wherein the central server includes control logic for comparing the specific spectral components with a current spectrum of the machine to determine if a specific fault exists.

8. The system as recited in claim 7, wherein the specific fault is at least one of a broken rotor bar, a damaged bearing, a misaligned shaft, static eccentricity and dynamic eccentricity.

9. The system as recited in claim 1, wherein the machine is one of a motor and a generator.

10. The system as recited in claim 1, comprising a remote monitoring unit (“RMU”) in communication with the digital protective relay, wherein the RMU includes control logic for monitoring the digital protective relay for the at least one parameter of the machine.

11. The system as recited in claim 10, wherein the RMU includes control logic for translating the data signal from the digital protective relay into a format for subsequent data processing.

12. The system as recited in claim 1, wherein the data signal from the digital protective relay is sent over the communications network at a specified interval of time that is about once a week.

13. A system for monitoring a motor, the system comprising:
a digital protective relay connected to the motor sampling at least one parameter of the motor at a rate of at least about twelve samples per power cycle;
a communications network providing a one-way network connection; and
a central server located remotely from the motor, the communications network providing a connection between the digital protective relay and the central server for sending a data signal representing the at least one parameter of the motor, the data signal only being communicated from the digital protective relay to the central server by the communications network.

14. The system as recited in claim 13, wherein the at least parameter from the motor is at least one of a current waveform and a voltage waveform.

15. The system as recited in claim 14, wherein the central server includes control logic for transforming the data signal representing the at least one parameter of the motor from a time domain signal into a frequency domain signal.

16. The system as recited in claim 15, wherein a fast Fourier transform (“FFT”) is used to transform the time domain signal into a frequency domain signal.

17. The system as recited in claim 16, wherein the central server includes control logic for creating graphical data representing the frequency domain signal, and wherein the graphical data is shown on a display.

18. The system as recited in claim 17, wherein the central server includes a memory, wherein a specific spectral component is saved on the memory of the central server, and wherein the central server includes control logic for comparing the specific spectral components with a current spectrum of the motor to determine if a specific motor fault exists.

19. The system as recited in claim 18, wherein the specific motor fault is at least one of a broken rotor bar, a damaged bearing, a misaligned shaft, static eccentricity and dynamic eccentricity.

20. The system as recited in claim 13, comprising a remote monitoring unit (“RMU”) in communication with the digital protective relay, wherein the RMU includes control logic for monitoring the digital protective relay for the at least one parameter of the motor, and wherein the RMU includes control logic for translating the data signal representing the at least one parameter of the motor into a format for subsequent data processing.
